(19) United States
(12) Patent Application Publication
(10) Pub. No.: US 2015/0162634 A1
(43) Pub. Date: Jun. 11, 2015

(54) PREPARATION METHOD OF ELECTROLYTES FOR SOLID OXIDE FUEL CELLS

(71) Applicant: National Central University, Taoyuan City (TW)

(72) Inventors: Sheng-Wei LEE, Taipei City (TW); Kan-Rong LEE, Tainan City (TW); Jing-Chie LIN, Taoyuan City (TW); Chuan LI, Taipei City (TW); Chung-Jen TSENG, Taoyuan City (TW); Jeng-Kuei CHANG, Kaohsiung City (TW); Shian-Ching JANG, Taoyuan City (TW); I-Ming HUNG, Tainan (TW); Chi-Shiung HSI, New Taipei City (TW); Sheng-Long LEE, Taoyuan City (TW); Yen-Jiun CHIANG, Taoyuan City (TW); Yu-Shuo HUANG, Taichung City (TW)

(21) Appl. No.: 14/622,644

(22) Filed: Feb. 13, 2015

Related U.S. Application Data
(63) Continuation-in-part of application No. 14/032,635, filed on Sep. 20, 2013.

(30) Foreign Application Priority Data
Aug. 1, 2013 (TW) 102127624

(51) Int. Cl. H01M 8/12; C04B 35/64; C04B 35/01; C04B 35/624

(52) U.S. Cl. CPC H01M 8/1246; C04B 35/624; C04B 35/64; C04B 35/01; H01M 2008/1293

(57) ABSTRACT

The preparation method of electrolytes provided by the present invention involves applications of a first solid oxide powder and a second solid oxide powder, both of which are prepared by using a sol-gel process and a calcination process. Each of the first and second solid oxide powders is a Perovskite-type oxide. After the first and second solid oxide powders are readily mixed, they are compressed into a pellet and then sintered to prepare the afore-mentioned electrolytes for SOFC. It is found in the present invention that by mixing and compressing different solid oxide powders, the solid oxide powder having smaller particle size can fill into the gaps of the other solid oxide powder. After the pellet is sintered, the density of the product is significantly improved.

### CROSS-REFERENCE TO RELATED APPLICATION

This patent application is a continuation-in-part of U.S. patent application Ser. No. 14/032,635 filed Sep. 20, 2013 entitled “Preparation Method Of Electrolytes For Solid Oxide Fuel Cells”, the entire disclosure of which is incorporated herein by reference.

### BACKGROUND OF THE INVENTION

1. Field of the Invention

The present invention relates generally to a preparation method of electrolytes for fuel cells, and more specifically to a preparation method of electrolytes for solid oxide fuel cells.

2. Description of the Related Art

Solid oxide fuel cells (SOFCs) have been recognized as high-efficient and clean power-generation devices due to their high thermodynamic efficiency, low environmental impact, and possibility of internal reforming of the fuel. Conventional SOFCs are composed of oxygen-ion-conducting electrolytes (O²⁻-SOFCs) and usually require operation at approximately 1000° C. Such a high operation temperature introduces many practical problems, such as high costs, materials degradations, thermal expansion mismatch, reactions between the components, and slow start-up and shut-off, etc.

In comparison with SOFCs based on oxygen-ion-conducting electrolytes, SOFCs based on proton-conducting electrolytes (H⁺-SOFCs) can be operated at an intermediate temperature range of 400-800° C. and thus gain increasingly interests in this field. Theoretically, H⁺-SOFCs have higher electromotive force (EMF) and electrical efficiency than O²⁻-SOFCs. The key issue in the development of H⁺-SOFCs is the use of a highly proton-conductive electrolyte with sufficient thermal stability at intermediate temperatures in various environments.

Perovskite-type oxides including BaCeO₃, BaZrO₃, SrCeO₃, and SrZrO₃ have been reported to exhibit predominant proton conduction at elevated temperature in hydrogen containing or humidified atmosphere. Among these proton-conductive electrolytes, BaCeO₃-based oxides are generally believed to have the highest conductivity. However, their chemical instability has been confirmed under CO₂, H₂O, or H₂S containing atmosphere at high temperature. Many efforts have been devoted to partially substitute Ce with Zr (BaCe₁₋ₓZrₓO) in the hope to improve the chemical stability. In addition, to enhance the protonic conduction in BaCe₁₋ₓZrₓO₃, doping with lower-valence cations is also essential. A trivalent dopant such as Y³⁺ can lead to the creation of oxygen vacancies, thus resulting in enhanced protonic conduction. Many studies have reported the promising performance of proton-conducting BaCe_{1-x-y}ZrA_{y}O_{3-δ} since it maintains the good chemical stability of BaZrO₃ but with improved electrical conductivity compared to BaCe₁₋ₓ,ZrₓO₃.

Several synthesis techniques have been utilized to prepare BaCe_{1-x-y}ZrA_{y}O_{3-δ} powders, including solid-state reaction, combustion and sol-gel, etc. The sol-gel process has gained considerable attention because it can produce powders with great compositional uniformity, low residual carbon level, and nano-scale particle size, which is important to make dense products at lower sintering temperatures.

On the other hand, protonic conductivity of Perovskites is found to be strongly affected by the basicity of the constituent oxides. Therefore, introducing highly basic alkaline cations into Perovskite oxides should further improve the protonic conductivity. A significantly higher conductivity has been shown in K-doped BaZrO₃ than that in undoped BaZrO₃. The water uptake of Y-doped BaZrO₃ synthesized by solid state reaction is also found to be increased with 5% K doped at the A-site of Perovskites. However, both works found that introducing K into Perovskites may lead to poor sinterability, high porosity, and second phase formation.

Therefore, it is desirable for one skilled in the art to prepare Perovskites having higher density and conductivity.

### SUMMARY OF THE INVENTION

It is a main objective of the present invention to provide a method of forming Perovskite with higher density such that it can be utilized as an electrolyte for an SOFC.

To achieve the above and other objectives of the present invention, a preparation method of electrolytes for solid oxide fuel cells is provided. The preparation method involves applications of a first solid oxide powder and a second solid oxide powder, both of which are Perovskite type oxides with different chemical formulas. Each of the first solid oxide powder and the second solid oxide powder is prepared by a sol-gel process and a subsequent calcination process. The first solid oxide powder and the second solid powder are uniformly mixed and then pressed into a pellet, which is then sintered to yield the electrolyte for the solid oxide fuel cell.

To achieve the above and other objectives of the present invention, a preparation method of electrolytes for solid oxide fuel cells is further provided. The preparation method involves applications of a first solid oxide powder and a second solid oxide powder, both of which are Perovskite type oxides having different average particle diameters. Each of the first solid oxide powder and the second solid oxide powder is prepared by a sol-gel process and a subsequent calcination process. The first solid oxide powder and the second solid powder are uniformly mixed and then pressed into a pellet, which is then sintered to yield the electrolyte for the solid oxide fuel cell.

In a possible embodiment, the first and second solid oxide powders are composed of different chemical elements. In other words, the composition of the first solid oxide powder is not entirely identical to that of the second solid oxide powder.

In a possible embodiment, the first and second solid oxide powders are composed of same chamical elements, and a ratio between at least two of the chemical elements in the first solid oxide powder is different from that between the chemical elements of the same kind in the second solid oxide powder.

In a possible embodiment, both the first and second solid oxide powders have compositions including at least one of Ba, Ce and Y.

In a possible embodiment, both the first and second solid oxide powders have compositions including at least two of Ba, Ce and Y.

In a possible embodiment, both the first and second solid oxide powders have compositions including Ba, Ce and Y.

In a possible embodiment, the first solid oxide powder has a composition including Ba, Ce, Y and O, while the second solid oxide powder has a composition including Ba, Sr, Ce, Zr, Y and O.

In a possible embodiment, the first solid oxide powder is Ba₁Ce_{0.8}Y_{0.2}O_{3-σ}, while the second solid oxide powder is Ba_{0.6}Sr_{0.4}Ce_{0.4}Zr_{0.4}Y_{0.2}O_{3-σ}.

Although the first solid oxide powder and the second solid oxide powder were prepared by the conventional method, the inventors of the present invention surprisingly found that if different solid oxide powders are mixed and pressed into a pellet, the powder with smaller particle size can fill into the pores of the other powder. After the pellet is sintered, the electrolyte generated can have significantly increased density.

### BRIEF DESCRIPTION OF THE DRAWINGS

The present invention can be understood more fully by referring to the detailed description below, as well as the accompanying drawings. However, it must be understood that both the descriptions and drawings are given by way of illustration only, and thus do not limit the present invention.

FIGS. 1a to 1d are SEM images of surface morphologies of four control groups in the first embodiment respectively;

FIGS. 2a to 2d are SEM images of surface morphologies of four experimental groups in the first embodiment respectively;

FIG. 2e is an SEM images in fractured cross-section view of the experimental group CE-3 in the first embodiment;

FIGS. 3a and 3c are SEM images of post-calcination, pre-sintering Ba₁₋ₓKₓCe_{0.6}Zr_{0.2}O_{3-δ} solid oxide powders with x values of 0 and 0.15 in the first embodiment respectively;

FIG. 3b is an SEM image of the pre-sintering experimental group CE-3 in the first embodiment;

FIG. 4a is a chart showing linear shrinkage vs. temperature of the experimental groups and the control groups in the first embodiment;

FIG. 4b is a chart showing densification temperature vs. K doping content of the experimental groups and the control groups in the first embodiment;

FIG. 5a is a chart showing the conductivity vs. operation temperature of the experimental groups and the control groups in the first embodiment;

FIG. 5b is a chart showing the conductivity vs. K doping content at 800° C. of the experimental groups and the control groups in the first embodiment;

FIG. 6 shows XRD patterns of the experimental group CE-3 pellet after exposure to CO₂ atmosphere at 600° C. for 0 hour, 8 hours and 16 hours in the first embodiment;

FIGS. 7a to 7d are SEM images of surface morphologies of four control groups in the second embodiment respectively;

FIGS. 8a to 8c are SEM images of surface morphologies of three experimental groups in the second embodiment respectively;

FIGS. 9a and 9b are SEM images of surface morphologies of Ba₁Ce_{0.8}Y_{0.2}O_{3-σ} solid oxide powder and Ba_{0.6}Sr_{0.4}Ce_{0.4}Zr_{0.4}Y_{0.2}O_{3-σ} solid oxide powder in the third embodiment respectively;

FIGS. 10a and 10b are SEM images of surface morphologies of two control groups in the third embodiment respectively;

FIG. 11 is an SEM image of surface morphology of the experimental group in the third embodiment.

### DETAILED DESCRIPTION OF THE INVENTION

The solid oxide product prepared by the present invention can be utilized as an electrolyte for a fuel cell. The present invention includes mixing different Perovskite type solid oxide powders uniformly, pressing the mixed powders into a pellet, and sintering the pellet to generate the solid oxide product. It is to be noted that “sintered solid oxide”, “solid oxide product”, and “electrolyte” mentioned in the present specification have substantially the same meaning. The density and other properties of experimental groups of the present invention and control groups prepared by the conventional method will be discussed hereinafter through several embodiments.

### The First Embodiment

Preparation of experimental groups: The first embodiment of the present invention takes Ba₁₋ₓKₓCe_{1-y-z}Zr_{y}Y_{z}O_{3-δ} Perovskite type oxides as examples of solid oxide powders. First of all, prepare five different Ba₁₋ₓKₓCe_{0.6}Zr_{0.2}O_{3-δ} solid oxide powders separately by a sol-gel process and a subsequent calcination process. The x values of these solid oxide powders are 0, 0.05, 0.1, 0.15 and 0.2 respectively. That is, the five solid oxide powders are BaCe_{0.6}Zr_{0.2}Y_{0.2}O_{3-δ} 6 (i.e. x=0), Ba_{0.95}K_{0.05}Ce_{0.6}Zr_{0.2}Y_{0.2}O_{3-δ} (i.e. x=0.05), Ba_{0.9}K_{0.1}Ce_{0.6}Zr_{0.2}Y_{0.2}O_{3-δ} (i.e. x=0.1), Ba_{0.85}K_{0.15}Ce_{0.6}Zr_{0.2}Y_{0.2}O_{3-δ} (i.e. x=0.15) and Ba_{0.8}K_{0.2}Ce_{0.6}Zr_{0.2}Y_{0.2}O_{3-δ} (i.e. x=0.2) respectively. These five solid oxide powders are different in both the average particle diameters and the chemical formulas.

In the present embodiment, the precursors of aforesaid Ba₁₋ₓKₓCe_{0.06}Zr_{0.2}O_{3-δ} solid oxide powders include Ba(NO₃)₂, KNO₃, ZrO(NO₃)₂.2H₂O, Ce(NO₃)₃.6H₂O, and Y(NO₃)₃.6H₂O. These precursors of the solid oxide powders are added into citrate-EDTA complexing solutions. Both citric acid and EDTA are used as chelating agents to complex metal cations. After the mixed solutions are stirred to obtain viscous gel, residual water and organics thereof are evaporated at elevated temperature, and thus the gels are converted into black powders. The synthesized powders are then calcined at 1000° C. for 12 hours with a heating rate of 5° C./min. Subsequently, the aforesaid Ba₁₋ₓKₓCe_{0.6}Zr_{0.2}O_{3-δ} solid oxide powders are prepared.

Thereafter, BaCe_{0.6}Zr_{0.2}Y_{0.2}O_{3-δ} is used as the first solid oxide powder, and Ba_{0.95}K_{0.05}Ce_{0.6}Zr_{0.2}Y_{0.2}O_{3-δ}, Ba_{0.9}K_{0.1}Ce_{0.6}Zr_{0.2}Y_{0.2}O_{3-δ}, Ba_{0.85}K_{0.15}Ce_{0.6}Zr_{0.2}Y_{0.2}O_{3-δ} and Ba_{0.8}K_{0.2}Ce_{0.6}Zr_{0.2}Y_{0.2}O_{3-δ} are separately used as the second solid oxide powder. The four second solid oxide powders are separately mixed with the first solid oxide powder by the molar ratio of 1:1 and uniformly stirred in 95% ethanol. All mixed powders are uniaxially pressed into pellets and then sintered in an atmosphere at 1600° C. for 4 hours. Thereby, four electrolyte experimental groups are obtained. The electrolyte made of BaCe_{0.6}Zr_{0.2}Y_{0.2}O_{3-δ} (i.e. x=0) and Ba_{0.95}K_{0.05}Ce_{0.6}Zr_{0.2}Y_{0.2}O_{3-δ} (i.e. x=0.05) are referred to as CE-1, whose average x value, i.e. the K doping content, is 0.025. The electrolyte made of BaCe_{0.6}Zr_{0.2}Y_{0.2}O_{3-δ} (i.e. x=0) and Ba_{0.9}K_{0.1}Ce_{0.6}Zr_{0.2}Y_{0.2}O_{3-δ} (i.e. x=0.1) are referred to as CE-2, whose average x value, i.e. the K doping content, is 0.05. The electrolyte made of BaCe_{0.6}Zr_{0.2}Y_{0.2}O_{3-δ} (i.e. x=0) and Ba_{0.85}K_{0.15}Ce_{0.6}Zr_{0.2}Y_{0.2}O_{3-δ} (i.e. x=0.15) are referred to as CE-3, whose average x value, i.e. the K doping content, is 0.075. The electrolyte made of BaCe_{0.6}Zr_{0.2}Y_{0.2}O_{3-δ} (i.e. x=0) and Ba_{0.8}K_{0.2}Ce_{0.6}Zr_{0.2}Y_{0.2}O_{3-δ} (i.e. x=0.2) are referred to as CE-4, whose average x value, i.e. the K doping content, is 0.1.

Thus, four experimental groups of the present embodiment, i.e. CE-1 to CE-4, are prepared.

Preparation of control groups: Four of the aforesaid five solid oxide powders, which have x values of 0, 0.05, 0.1 and 0.15 respectively, are separately pressed and sintered to obtain four electrolyte control groups. In other words, the electrolyte control groups are prepared by the conventional method because solid oxide powders are not mixed before pressed and sintered. We note that the sintered pellet with x value of 0.2 was not successfully fabricated due to its high porosity. This result indicates that adding K into Ba₁₋ₓKₓCe_{0.6}Zr_{0.2}Y_{0.2}O_{3-δ} oxides would lead to poor sinterability and high porosity in sintering.

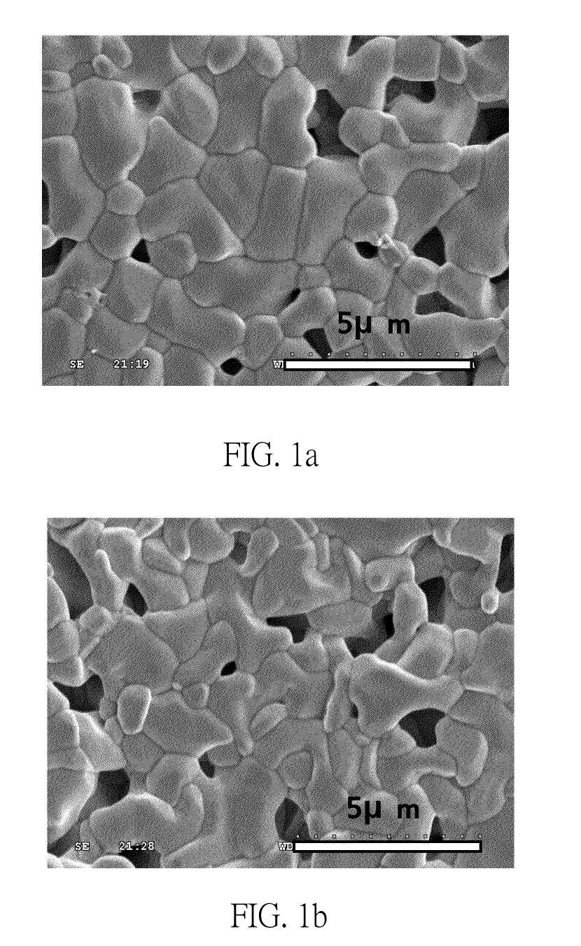

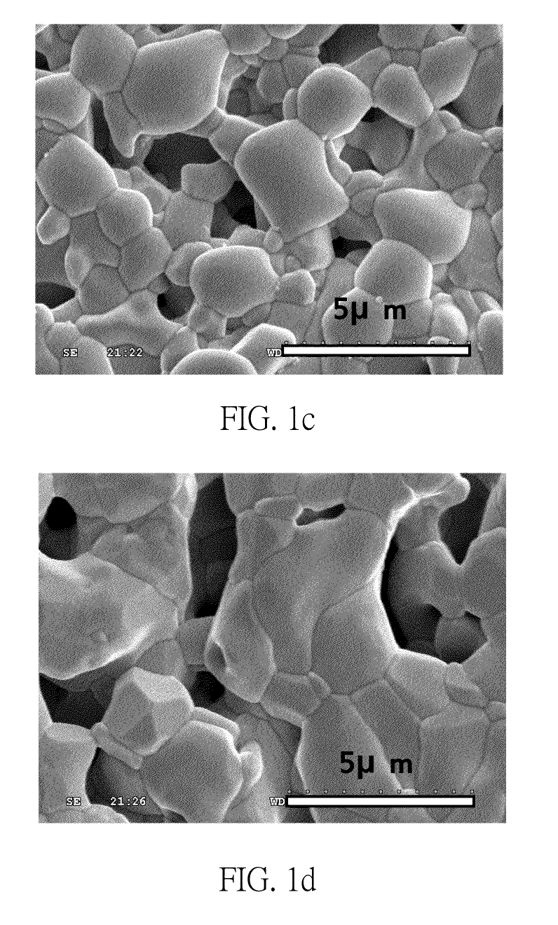

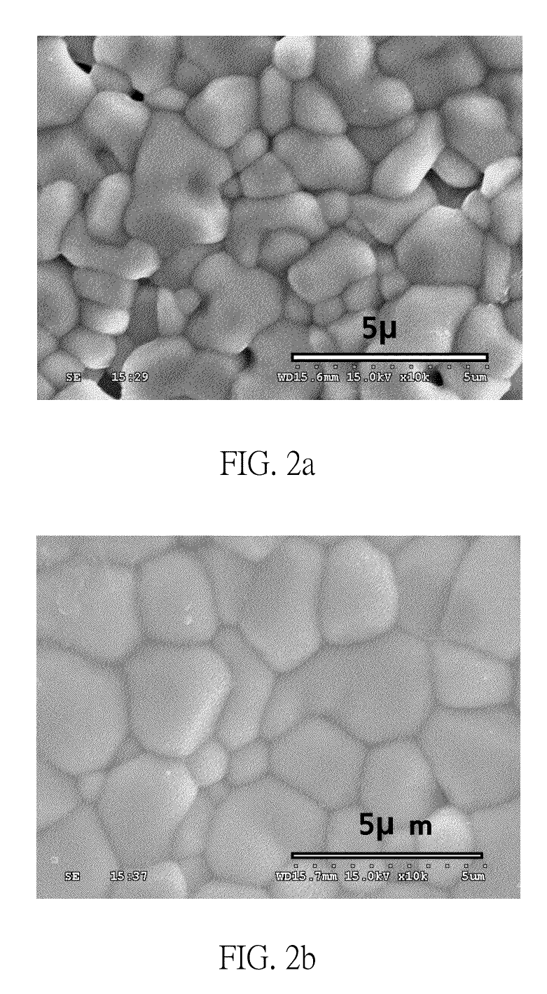

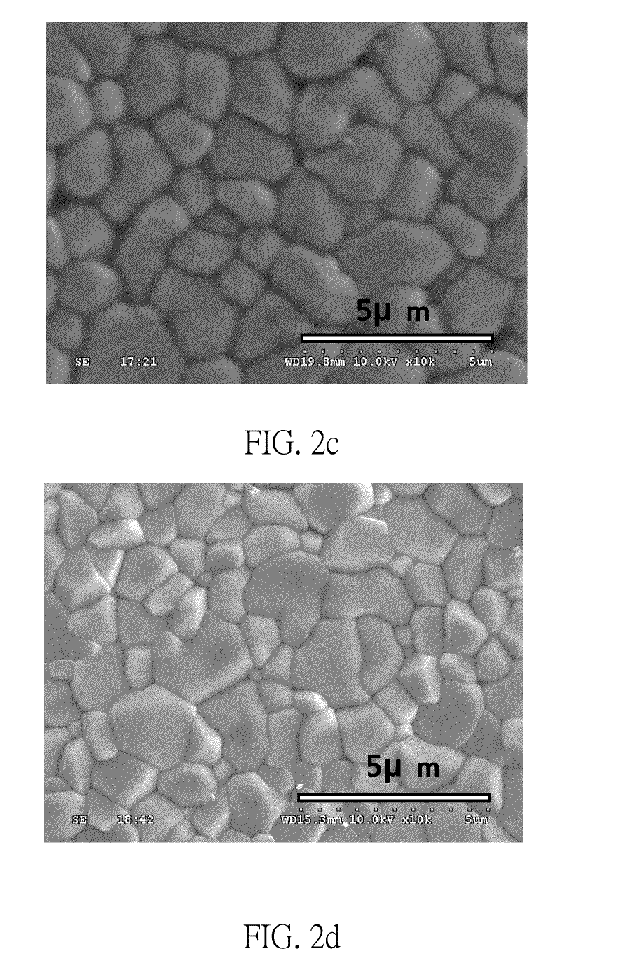

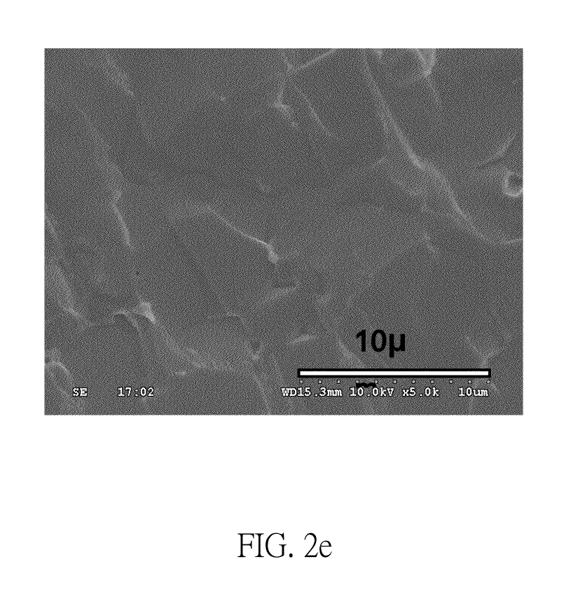

Surface morphologies discussion: Surface morphologies of the four control groups, as shown in FIGS. 1a-1d respectively, and the four experimental groups, as shown in FIGS. 2a-2d respectively, are examined using field-emission scanning electron microscope (FESEM). As shown in FIGS. 1a-1d, the electrolytes prepared from the conventional method have lower density, and the grain size thereof significantly increases with increasing x value. Meanwhile, an increasing number and size of pores are observed on the pellet surface. These pores can be ascribed to the oxide volume shrinkage, which results from the release of structural water and residual organics, and volatilization of K-doped oxide at high sintering temperature. On the other hand, the experimental groups of the present invention exhibit denser surface as shown in FIGS. 2a-2d. FIG. 2e shows the representative SEM micrograph taken from the fractured cross section of the CE-3 experimental group. The image shows that the interior structure of the electrolyte is also well densified, indicating an obvious improvement in sinterability of the pressed powders processed by the present invention.

Accordingly, we find that the electrolyte with K doping prepared from the present invention exhibits considerably elevated densification and would be a promising electrolyte for H⁺-SOFC despite the fact that the SEM images of the control groups shows the fact that the K doping in the electrolyte can lead to poor sinterability and high porosity when the electrolyte is prepared by the conventional method.

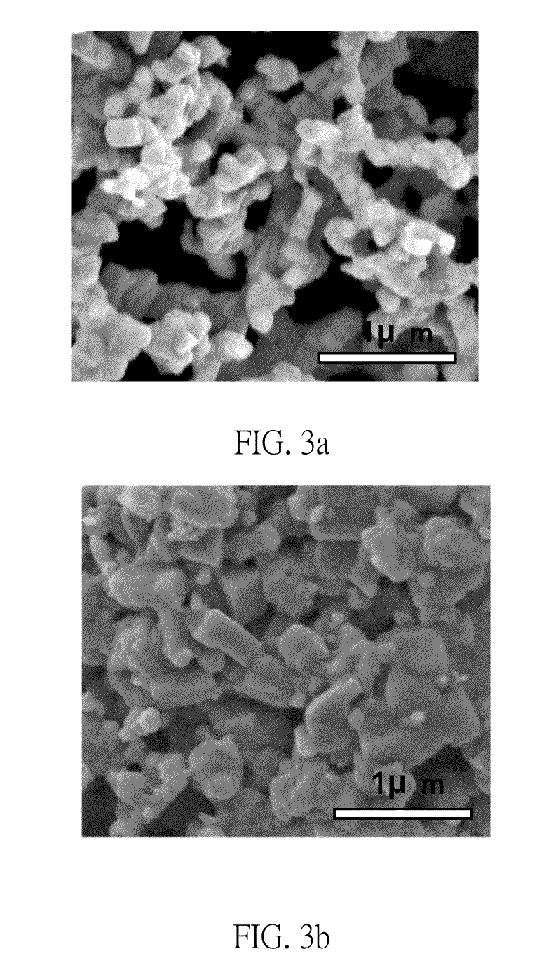

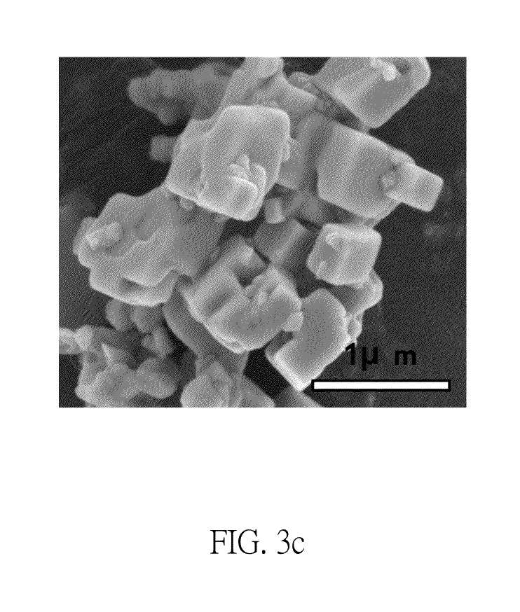

We attempt to discuss the mechanism for the above-mentioned improvement in terms of calcined particle characteristics before the solid oxide powder is sintered. FIGS. 3a and 3c show the SEM images of control groups with x values of 0 and 0.15 respectively. The K doping content significantly affects the particle size of calcined powders. For example, the calcined powders with x value of 0.15 have particle size ranging from 350-850 nm, which is much larger than that of the non-doped powders, 85 nm in average. The larger-particle size and correspondingly larger gaps between particles can provide pathways for the release of structural water and volatilization of K-based oxide, leading to higher porosity in the sintered pellets as seen in FIG. 2d. On the other hand, the CE-3 calcined powders prepared by the present invention, as shown in FIG. 3b, exhibit bimodal particle size distribution since it's a mixture of two K-doped powders with x values of 0 and 0.15 respectively. We speculate that the smaller calcined particles can fill the gaps between the larger particles when they are uniformly mixed and pressed into a pellet. The CE-3 pellet pressed from such mixed powders may give fewer pathways for the release of structural water and volatilization of K-based oxide during sintering, thus resulting in an improvement in sinterability and a considerably dense structure in sintered pellet.

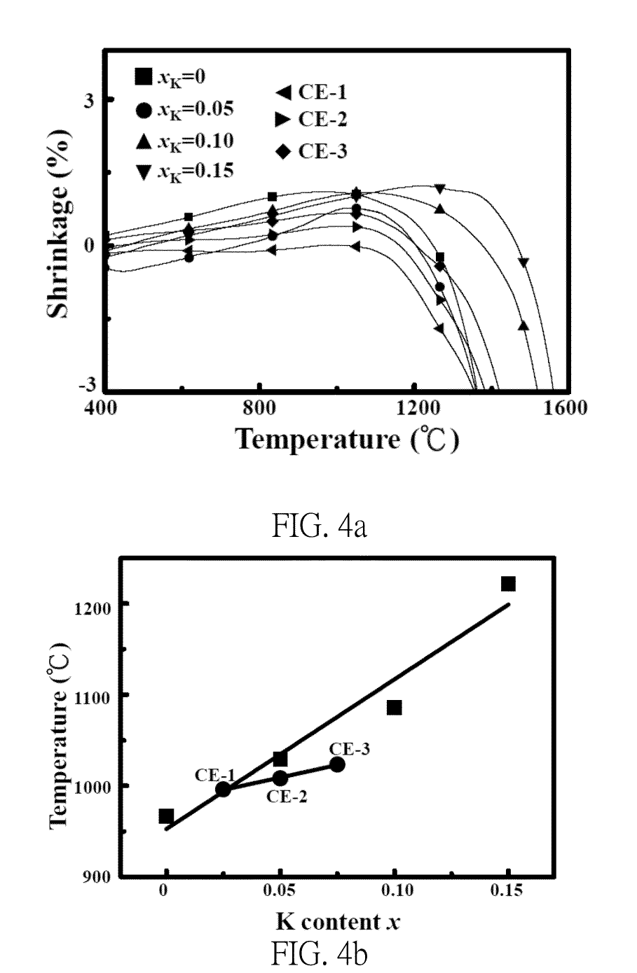

Sinter temperature discussion: FIG. 4a shows linear shrinkage vs. temperature of the experimental groups and the control groups, and FIG. 4b shows densification temperature vs. K doping content of the experimental groups and the control groups. We find that an increase in the K doping content significantly elevates the densification temperature of the Ba₁₋ₓKₓCe_{0.6}Zr_{0.2}Y_{0.2}O_{3-δ} pellets processed by the conventional method. We also observe that the experimental groups of the present invention have a lower densification temperature compared to those with the similar nominal K doping prepared from the conventional method. This indicates that an appropriate bimodal size distribution of calcined particles processed by the present invention is more beneficial for fabricating dense ceramic oxides at lower sintering temperature.

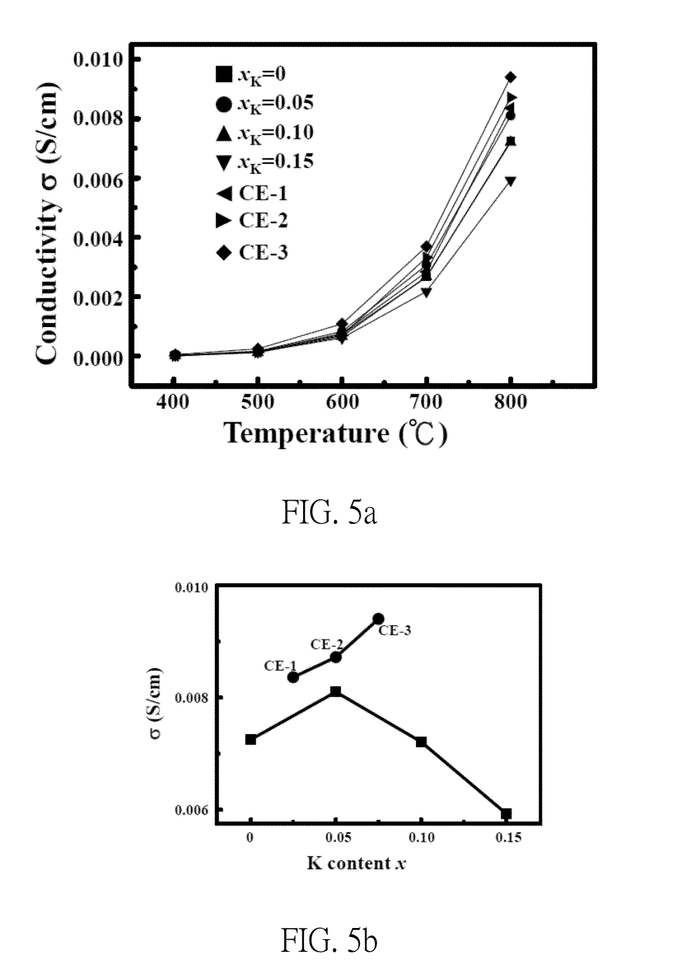

Conductivity discussion: Electrolyte conduction directly affects the overall energy conversion performance of H⁺-SOFCs. Here, the ionic conductivity tests of the control groups and the experimental groups were conducted in an air atmosphere with 3% relative humidity. FIG. 5a shows the conductivity vs. operation temperature of the experimental groups and the control groups, and FIG. 5b shows the conductivity vs. K doping content at 800° C. of the experimental groups and the control groups. We find that the increase in conductivity with increasing temperature indicates that all sintered pellets exhibit ionic conduction. For the electrolyte of control groups, the conductivity is increased to a maximal value by an addition of 5% K doping. Further increasing the K doping content dramatically decreases the oxide conductivities of the control groups due to their high structural porosity. On the other hand, the conductivities of the experimental groups shown an increasing trend with the increasing K doping. Among all the electrolytes in the present embodiment, the CE-3 experimental group has the highest conductivity, 0.0094 S/cm at 800° C., which is considerably higher than the control groups in the K doping range of 0%-15%.

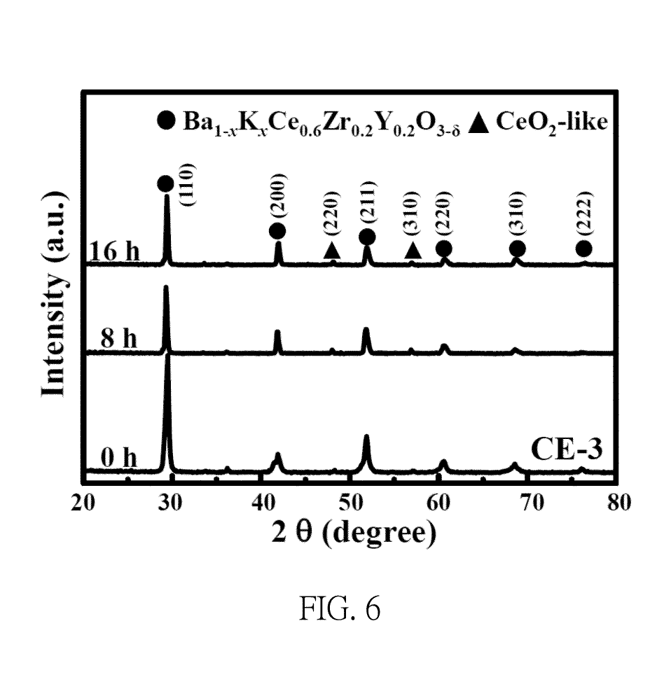

Chemical stability discussion: One major advantage of H⁺-SOFCs is the capability of using hydrocarbon fuels instead of pure hydrogen. The hydrocarbon gas can be in-situ reformed into CO₂ and H₂ by the catalysts on the H⁺-SOFC anodes. It is essential to ensure that the materials have thermodynamic or at least long-term kinetic stability in addition to good conductivity in the application environment for the electrolyte of H⁺-SOFC. Therefore, the operational reliability of ceramic electrolytes in the CO₂-containing atmosphere is important. In order to verify the chemical stability, the CE-3 pellet was exposed to pure CO₂ in a tube furnace at 600° C. for long duration and the phase evolution was identified by XRD. It is found that the CE-3 pellet exhibits excellent chemical stability against CO₂ even after exposure to CO₂ for 16 hours. As shown in FIG. 6, the XRD peaks from original Perovskite phase remain almost unchanged and no decomposition of Ba₁₋ₓKₓCe_{0.6}Zr_{0.2}Y_{0.2}O_{3-δ} into BaCO₃ or

CeO₂ is detected. This indicates that the electrolyte prepared by the present invention exhibits high chemical stability.

### The Second Embodiment

Preparation of experimental groups: In order to verify that the present invention is also applicable to other Perovskite oxides, the second embodiment of the present invention takes BaZr_{0.2}Ce_{0.8-x}YₓO_{3-δ} Perovskite oxides as examples of solid oxide powders. Four BaZr_{0.2}Ce_{0.8}YₓO_{3-δ} solid oxide powders with x values of 0, 0.2, 0.4 and 0.6 respectively are also separately prepared by a sol-gel process in combination with a calcination process.

BaZr_{0.2}Ce_{0.8-x}YₓO_{3-δ} solid oxide powder with x value of 0 is utilized as the first solid oxide powder, and BaZr_{0.2}Ce_{0.8-x}YₓO_{3-δ} solid oxide powders with x values of 0.2, 0.4 and 0.6 are separately utilized as the second solid oxide powder. The three second solid oxide powders are separately and uniformly mixed with the first solid oxide powder by the molar ratio of 1:1, and then the mixed powders are pressed and sintered to obtain three experimental groups. The electrolyte experimental group made of BaZr_{0.2}Ce_{0.8}O_{3-δ} (i.e. x=0) and BaZr_{0.2}Ce_{0.6}Y_{0.2}O_{3-δ} (i.e. x=0.2) are referred to as CE-5, whose average x value, i.e. the Y doping content, is 0.1. The electrolyte experimental group made of BaZr_{0.2}Ce_{0.8}O_{3-δ} (i.e. x=0) and BaZr_{0.2}Ce_{0.4}Y_{0.4}O_{3-δ} (i.e. x =0.4) are referred to as CE-6, whose average x value, i.e. the Y doping content, is 0.2. The electrolyte experimental group made of BaZr_{0.2}Ce_{0.8}O_{3-δ} (i.e. x=0) and BaZr_{0.2}Ce_{0.2}Y_{0.6}O_{3-δ} (i.e. x=0.6) are referred to as CE-7, whose average x value, i.e. the Y doping content, is 0.3.

Thus, three experimental groups of the present embodiment, i.e. CE-5 to CE-7, are prepared.

Preparation of control groups: The afore-prepared four solid oxide powders, without mixing, are separately pressed and sintered to obtain four electrolyte control groups.

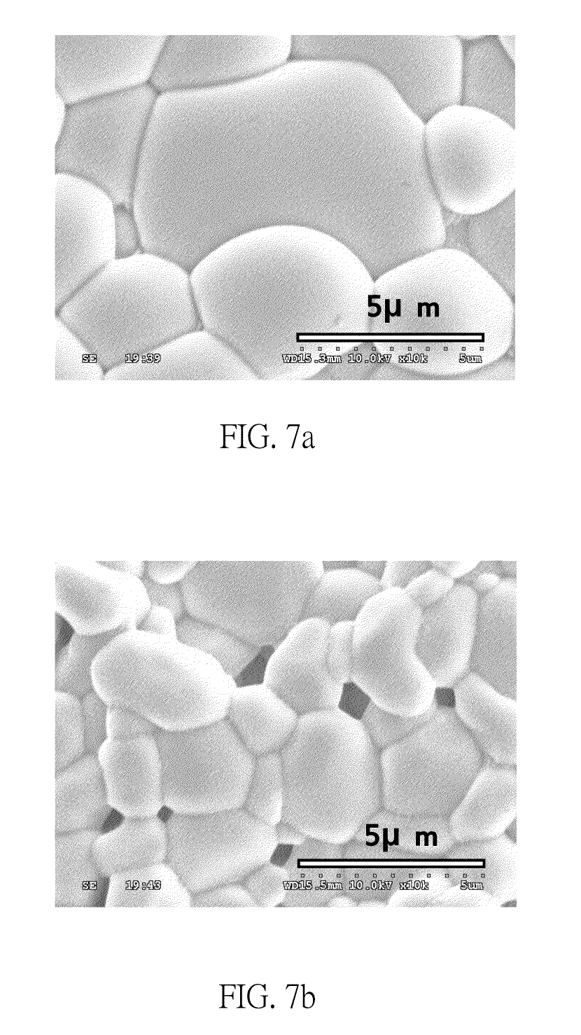

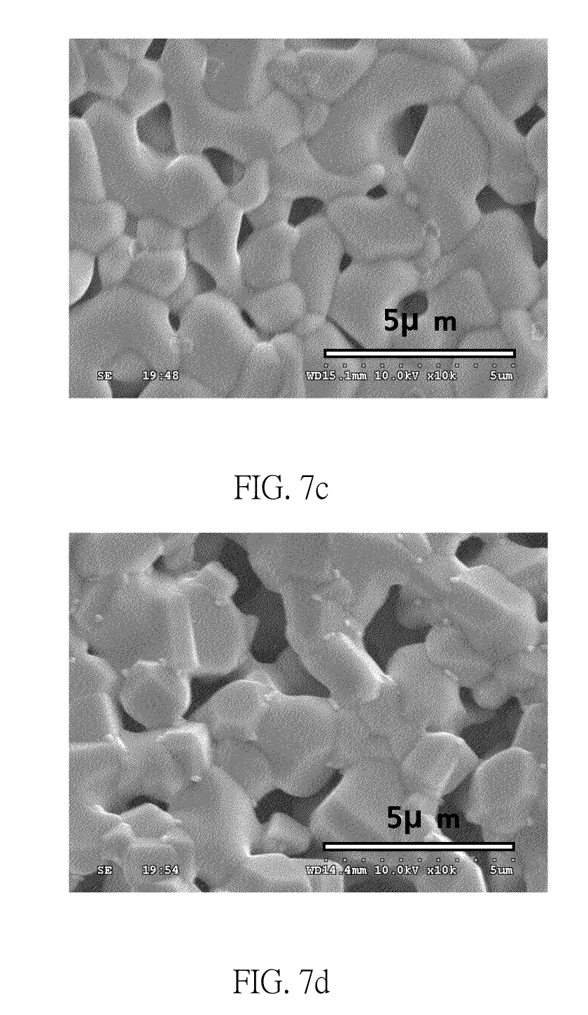

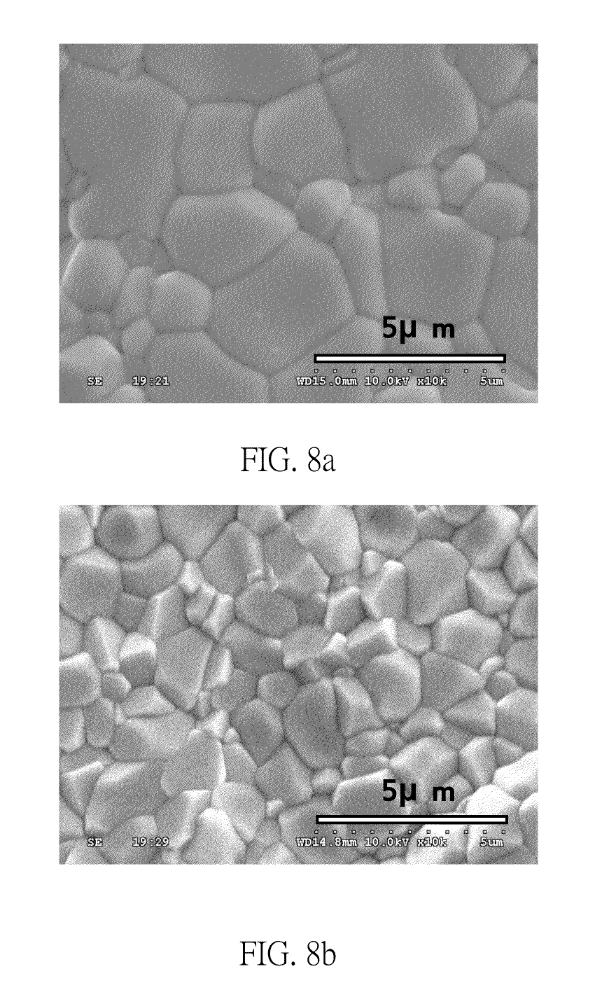

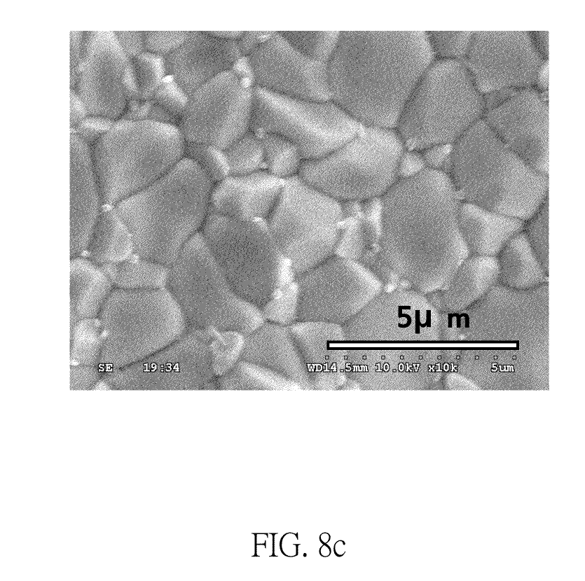

Surface morphologies discussion: Surface morphologies of the four control groups, as shown in FIGS. 7a-7d respectively, and the three experimental groups, as shown in FIGS. 8a-8c respectively, are examined using field-emission scanning electron microscope. As shown in FIGS. 7a-7d, obvious pores can be found on the surface of the control groups with Y doping content other than 0. On the other hand, the surface densification of the experimental groups prepared by the present invention can be considerably elevated despite the fact that they all have at least 10% Y doping content. This indicates that the present invention is applicable to various kinds of Perovskite solid oxides.

### The Third Embodiment

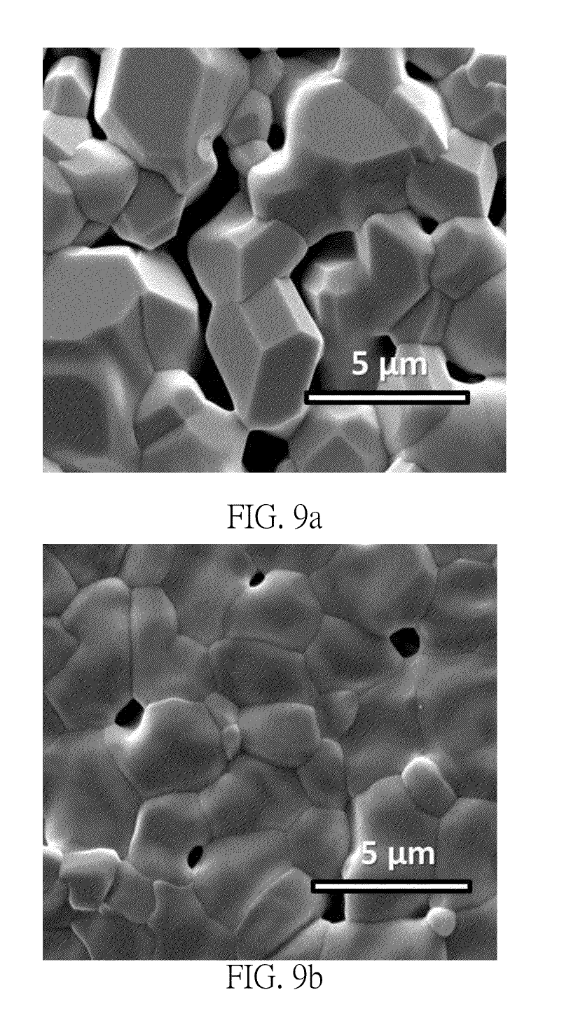

Preparation of experimental group: In order to verify that the present invention is also applicable to Perovskite oxides having different elements of composition, the third embodiment of the present invention prepares, in the similar sol-gel process and the subsequent calcination process as mentioned above, Ba₁Ce_{0.8}Y_{0.2}O_{3-σ} solid oxide powder (as shown in FIG. 9a) and Ba_{0.6}Sr_{0.4}Ce_{0.4}Zr_{0.4}Y_{0.2}O_{3-σ} solid oxide powder (as shown in FIG. 9b), in which the solid oxide powders are also different in average particle diameters.

Ba₁Ce_{0.8}Y_{0.2}O_{3-σ} solid oxide powder is used as the first solid oxide powder, and Ba_{0.6}Sr_{0.4}Ce_{0.4}Zr_{0.4}Y_{0.2}O_{3-σ} solid oxide powder is used as the second solid oxide powder. The first and second solid oxide powders are uniformly mixed by the molar ratio of about 1:1, pressed into pellets and then sintered to yield the experimental group CE-8 of the present embodiment.

Preparation of control groups: The afore-prepared two solid oxide powders, without mixing, are separately pressed and sintered to obtain two electrolyte control groups.

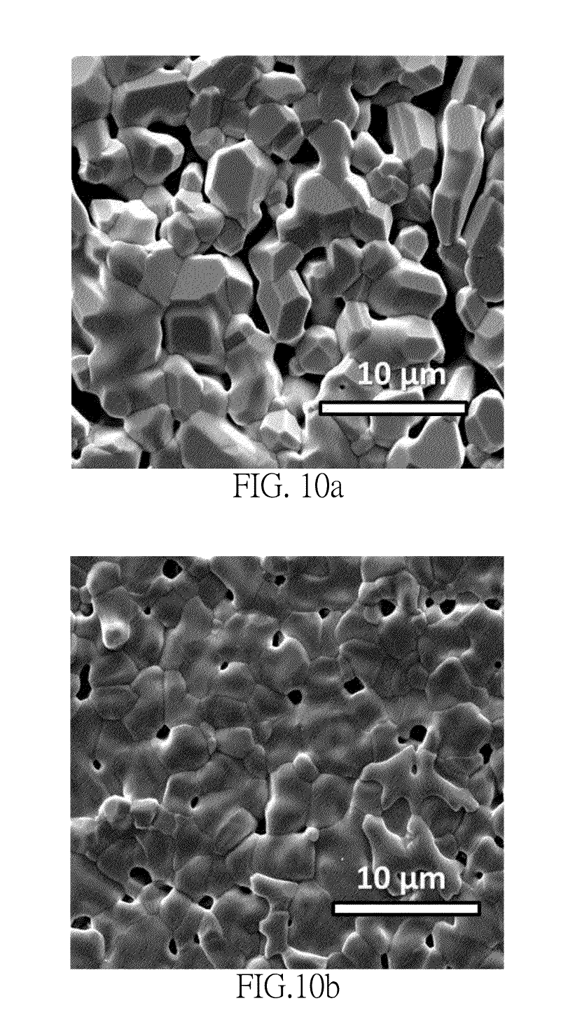

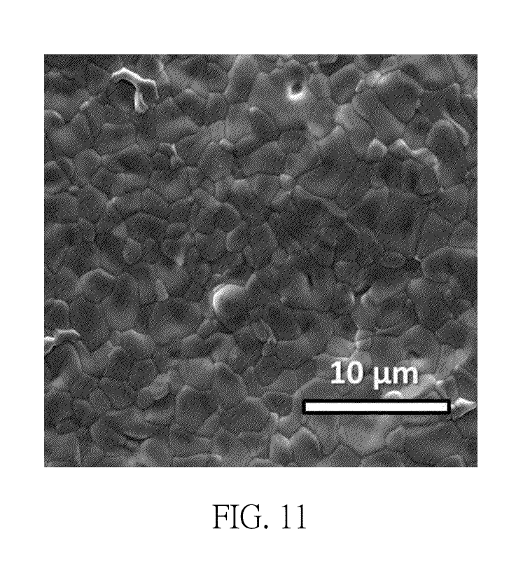

Surface morphologies discussion: Surface morphologies of the two control groups, as shown in FIGS. 10a and 10b respectively, and the experimental group CE-8, as shown in FIGS. 11, are examined using field-emission scanning electron microscope. Apparently, pores can be obviously observed on the surfaces of the control groups, while the pore is hardly found on the surface of the experimental group CE-8. Such fact indicates that the density of the experimental group CE-8 is significantly elevated.

In conclusion, the present invention provides a method to synthesis electrolytes for SOFCs by mixing different Perovskite solid oxide powders before pressing and sintering. The structural density, conductivity, chemical stability of the sintered solid oxide are significantly increased. And thus the sintered solid oxide prepared by the present invention would be a promising electrolyte for H^{t}-SOFC applications.

The invention described above is capable of many modifications, and may vary. Any such variations are not to be regarded as departures from the spirit of the scope of the invention, and all modifications which would be obvious to someone with the technical knowledge are intended to be included within the scope of the following claims.

What is claimed is:

1. A preparation method of electrolytes for solid oxide fuel cells, involving applications of a first solid oxide powder and a second solid oxide powder, the first and second solid oxide powders are Perovskite type oxides with different chemical formulas, each of the first solid oxide powder and the second solid oxide powder being prepared by a sol-gel process and a subsequent calcination process, the preparation method being characterized in that:
the first solid oxide powder and the second solid oxide powder are uniformly mixed and then pressed into a pellet, which is then sintered to yield the electrolyte for the solid oxide fuel cell.

2. The preparation method of claim 1, wherein the first and second solid oxide powders have different average particle diameters.

3. The preparation method of claim 1, wherein the first and second solid oxide powders are composed of different chemical elements.

4. The preparation method of claim 1, wherein the first and second solid oxide powders are composed of same chemical elements, a ratio between at least two of the chemical elements in the first solid oxide powder is different from that between the chemical elements of the same kind in the second solid oxide powder.

5. The preparation method of claim 1, wherein both the first and second solid oxide powders have compositions comprising at least one of Ba, Ce and Y.

6. The preparation method of claim 1, wherein both the first and second solid oxide powders have compositions comprising at least two of Ba, Ce and Y.

7. The preparation method of claim 1, wherein both the first and second solid oxide powders have compositions comprising Ba, Ce and Y.

8. The preparation method of claim 1, wherein the first solid oxide powder has a composition comprising Ba, Ce, Y and O, the second solid oxide powder has a composition comprising Ba, Sr, Ce, Zr, Y and O.

9. The preparation method of claim 1, wherein the first solid oxide powder is Ba₁Ce_{0.8}Y_{0.2}O_{3-σ}, the second solid oxide powder is Ba_{0.6}Sr_{0.4}Ce_{0.4}Zr_{0.4}Y_{0.2}O_{3-σ}.

10. A preparation method of electrolytes for solid oxide fuel cells, involving applications of a first solid oxide powder and a second solid oxide powder, the first and second solid oxide powders are Perovskite type oxides having different average particle diameters, each of the first solid oxide powder and the second solid oxide powder being prepared by a sol-gel process and a subsequent calcination process, the preparation method being characterized in that:
the first solid oxide powder and the second solid oxide powder are uniformly mixed and then pressed into a pellet, which is then sintered to yield the electrolyte for the solid oxide fuel cell.

11. The preparation method of claim 10, wherein the first and second solid oxide powders are composed of different chemical elements.

12. The preparation method of claim 10, wherein the first and second solid oxide powders are composed of same chemical elements, a ratio between at least two of the chemical elements in the first solid oxide powder is different from that between the chemical elements of the same kind in the second solid oxide powder.

13. The preparation method of claim 10, wherein both the first and second solid oxide powders have compositions comprising at least one of Ba, Ce and Y.

14. The preparation method of claim 10, wherein both the first and second solid oxide powders have compositions comprising at least two of Ba, Ce and Y.

15. The preparation method of claim 10, wherein both the first and second solid oxide powders have compositions comprising Ba, Ce and Y.

16. The preparation method of claim 10, wherein the first solid oxide powder has a composition comprising Ba, Ce, Y and O, the second solid oxide powder has a composition comprising Ba, Sr, Ce, Zr, Y and O.

17. The preparation method of claim 10, wherein the first solid oxide powder is Ba₁Ce_{0.8}Y_{0.2}O_{3-σ}, the second solid oxide powder is Ba_{0.6}Sr_{0.4}Ce_{0.4}Zr_{0.4}Y_{0.2}O_{3-σ}.
